(19) United States
(12) Patent Application Publication
(10) Pub. No.: US 2026/0224045 A1
(43) Pub. Date: Aug. 6, 2026

(54) HEADREST ADJUSTING MECHANISM AND BABY CARRIER

(71) Applicant: WONDERLAND SWITZERLAND AG, Steinhausen (CH)

(72) Inventors: Ruyi LI, Dongguan, Guangdong (CN); Daliang ZHANG, Dongguan, Guangdong (CN); Jiajun LIANG, Dongguan, Guangdong (CN)

(73) Assignee: WONDERLAND SWITZERLAND AG, Steinhausen (CH)

(21) Appl. No.: 19/152,858

(22) PCT Filed: Jan. 9, 2024
(86) PCT No.: PCT/EP2024/050323

§ 371 Date: Jul. 31, 2025

(30) Foreign Application Priority Data
Feb. 2, 2023 (CN) 2023100808968

(51) Int. Cl. A47D 13/02

(52) U.S. Cl. CPC A47D 13/025

(57) ABSTRACT

The present disclosure provides a headrest adjusting mechanism for adjusting a longitudinal position of a headrest with respect to a seat body of a baby carrier, and the headrest adjusting mechanism includes a headrest plate and an adjustment belt provided at the seat body for connecting the headrest plate and the seat body, wherein the headrest plate is provided with an adjusting member which clamps the adjustment belt for adjusting the position of the headrest plate along a length direction of the adjustment belt. The disclosure relates to a baby carrier.

### CROSS-REFERENCE TO RELATED APPLICATIONS

This application is a U.S. National Stage Application of PCT/EP2024/050323, entitled “Headrest Adjusting Mechanism And Baby Carrier,” filed on Jan. 9, 2024, which claims the benefit of Chinese Application No. 2023100808968, filed on Feb. 2, 2023, all of which are incorporated herein by reference in their entirety.

### TECHNICAL FIELD

This disclosure relates to a headrest adjusting mechanism and a baby carrier with the headrest adjusting mechanism.

### BACKGROUND

Baby carriers, such as baby carrycots, strollers, baby slings, baby seats, and child safety seats, offer convenience and ensure safety for babies during travel. As an example of a baby carrycot, it typically includes a seat body and a headrest. To facilitate the babies of different sizes, the headrest is generally designed to be adjustable in up and down directions along a backrest portion. However, the headrest designed for the baby carrycot currently available in market mostly has a complicated mechanical structure with numerous components, making it inconvenient to use. Furthermore, the headrest adjusting mechanism may increase weight of the carriage, making it difficult for caregivers to carry the baby carrycot.

### SUMMARY

The present disclosure provides a headrest adjusting mechanism for adjusting a position of a headrest with respect to a seat body of a baby carrier. The headrest adjusting mechanism includes a headrest plate and an adjustment belt provided at the seat body, for connecting the headrest plate and the seat body, wherein the headrest plate has an adjusting member that is configured to clamp the adjustment belt for adjusting a position of the headrest plate along a length direction of the adjustment belt. According to the present disclosure, the headrest is slidably connected to the seat and may be adjusted advantageously up and down in the longitudinal direction with respect to the seat, in order to accommodate babies of different heights.

According to an embodiment of the present disclosure, the headrest plate and the adjusting member are integrated, so that the number of mechanical structural pieces can be reduced, and the structure of the headrest adjusting mechanism is simpler.

According to an embodiment of the present disclosure, the adjusting member protrudes from a surface of the headrest plate toward a direction facing the seat body. This can reduce a contact area between the headrest plate and the seat body and reduce resistance when adjusting the headrest.

According to an embodiment of the present disclosure, the adjusting member includes at least one first positioning arm and at least two second positioning arms provided at intervals.

According to an embodiment of the present disclosure, the adjustment belt is flat and has a first face and a second face, wherein the first face abuts against the first positioning arm of the adjusting member and the second face abuts against the second positioning arm of the adjusting member. The flat adjustment belt can make the structure of the headrest adjusting mechanism more compact and adapt to a sheet-like headrest plate to improve the riding comfort. In addition, there is a larger contact surface between the flat adjustment belt and the positioning arm to increase friction force.

According to an embodiment of the present disclosure, the first positioning arm and the second positioning arm are in the same plane or in different planes. In the case that the first positioning arm and the second positioning arm are located in the same plane, the portion of the adjustment belt abutting against the first positioning arm can form a raised portion, to increase a pressure between the adjustment belt and the first and second positioning arms, thereby increasing the friction. In the case that first positioning arm and the second positioning arm are in different planes, a position of the adjustment hole for the adjustment belt may be set as desired.

According to an embodiment of the present disclosure, a resistance device is formed at a surface of at least one of the first positioning arm and the second positioning arm abutting against the adjustment belt to increase the friction between the adjusting member and the adjustment belt.

According to an embodiment of the present disclosure, the resistance device is configured as a protrusion, which is provided on the surface of the adjusting member facing the adjustment belt. This can increase the friction between the adjusting member and the adjustment belt with a simple structured potion. The protrusion can be tooth-like protrusion, anti-slip rib, rough surface, etc.

According to an embodiment of the present disclosure, the adjustment belt has a plurality of sewing lines extending perpendicular to the length direction of the adjustment belt. In this embodiment, a roughened portion between the adjusting member and the adjustment belt is formed by a simple process and allows the adjusting member easily to retain near the sewing line at a predetermined position.

According to an embodiment of the present disclosure, the adjusting member is configured to have two or more through holes, at which the adjustment belt may be configured to pass. The adjusting member is provided with through holes allowing the passage of the adjustment belt, and the adjusting member cooperates with the adjustment belt through the through holes, so that the headrest plate can be adjustably fixed at a plurality of continuous positions in the longitudinal direction, to accommodate the babies of different heights, and prevent the headrest from moving freely up and down in use.

According to an embodiment of the present disclosure, the headrest adjusting mechanism has a fixing member provided on the seat body along the longitudinal direction of the seat body, and the fixing member fixes the adjustment belt to the seat body. By arranging the fixing member to be separated from the seat body, different types of fixing members can be individually arranged according to different needs, such as different screw accommodating portion and adjustment belt accommodating portion, and the fixing member can be easily replaced to adapt to different seat bodies.

According to an embodiment of the present disclosure, the fixing member is configured to have a groove extending substantially along the longitudinal direction of the seat body, and the groove has a bottom portion and side portions respectively at both lateral sides of the bottom portion. According to this embodiment, the adjustment belt is advantageously buried in the groove of the fixing member, and the fixing member, together with the adjustment belt, is buried in the backrest portion, and is fixedly connected with the backrest portion or the seat body covered by the backrest portion through the screws provided at the connecting portions at both ends. This makes the structure more compact. The protruded adjusting member of the headrest plate may be matched with the groove, thereby reducing a gap between the headrest plate and the seat body.

According to an embodiment of the present disclosure, the adjusting member has side wings respectively located at two lateral sides, and the side wings are inserted and matched with the side portions of the fixing member, so that the headrest plate can slide and position with respect to the seat body. The side wings protrude from the adjustment belt in a lateral direction and may be inserted into the corresponding guide grooves, so that the adjusting member can slide in the guide grooves and the headrest plate can be prevented from being separated from the backrest portion.

According to an embodiment of the present disclosure, the adjusting member has a positioning member that cooperates with the positioning portion on the groove to position the headrest plate.

According to an embodiment of the present disclosure, the positioning member is provided on an outer surface of the bottom side of the adjusting member facing the bottom portion of the groove. According to this embodiment, the positioning member is vertically provided on the outer surface of the bottom side of the adjusting member facing the bottom portion of the groove of the fixing member. When the convex portion or rather the positioning protrusion is provided in a vertical direction, an upper end of the headrest is pulled to adjust the height of the headrest, on the one hand, a pulling force is applied to the headrest plate in the vertical direction to keep the headrest plate away from the seat body, so that the convex portion or the positioning protrusion on the surface of the adjusting member of the headrest plate is at least partially disengaged from the positioning recess on the fixing member, thereby reducing the resistance when adjusting the height of the headrest; on the other hand, a pulling force is provided for the headrest in the longitudinal direction to adjust the height of the headrest along the length direction of the adjustment belt.

According to an embodiment of the present disclosure, the positioning member is provided on the outer surface of the side portion of the adjusting member facing the groove. According to this embodiment, an operation mode is simplified.

According to an embodiment of the present disclosure, the positioning portion is configured as a wave-like positioning portion, and the positioning member moves along the wave-like positioning portion and is positioned in a trough. The wave-like positioning portion allows for the movement and the positioning of the adjusting member in a continuous way, providing users with an intuitive sense of positioning.

According to an embodiment of the present disclosure, the adjustment belt is provided with an elastic arm which is deformable in a direction perpendicular to the longitudinal direction; and the positioning member is configured on the elastic arm. The elastic arm can achieve smooth movement and positioning of the adjusting member through its own deformation.

According to an embodiment of the present disclosure, the positioning member is configured on the side wing, so that the anti-detachment and guiding functions attached to the side wing realize lateral positioning.

According to an embodiment of the present disclosure, one of the positioning member and the positioning portion is presented as a plurality of convex portions, and the other of the positioning member and the positioning portion is presented as a plurality of concave portions matched with the convex portions.

According to an embodiment of the present disclosure, along a longitudinal direction of the seat body, the adjustment belt has an upper end that is fixed to the bottom side of the fixing member through a perforation in upper part of the fixing member, and a lower end that is fixed to outside the fixing member through the perforation in lower part of the fixing member. Fixing points at the upper and lower ends of the adjustment belt are not on the same plane with the length direction of the adjustment belt, to firmly fix the adjustment belt and prevent the adjustment belt from loosening.

According to an embodiment of the present disclosure, anti-slip rib is provided on a surface of the headrest plate facing the seat body. The headrest plate has a curvature so that there is a gap between the anti-slip ribs and the seat body. The anti-slip rib is used to increase the friction between the hand and the headrest plate when this position can be gripped by the users to adjust the height of the headrest.

According to an embodiment of the present disclosure, the headrest plate has a sheet-like structure, and the headrest plate has a plurality of hollowed-out portions. The hollowed-out portions can be matched with the hollowed-out portions in the backrest portion or rather the seat body. This can provide the passage of the shoulder strap and/or the ventilation of the backrest, and also reduce the weight of the components advantageously.

According to an embodiment of the present disclosure, the adjustment belt is a flexible material. The flexible material generally has a larger contact area, which can advantageously improve the friction between the adjustment belt and the adjusting member.

According to an embodiment of the present disclosure, the adjustment belt is a woven tape. The woven tape has a rough surface that can provide greater friction force than the smooth surface.

The present disclosure provides a baby carrier, which includes a seat body, a headrest, and the headrest adjusting mechanism according to the present disclosure provided between the seat body and the headrest. Through the headrest adjusting mechanism according to the present disclosure, the headrest is slidably connected to the seat and may be adjusted up and down in the longitudinal direction with respect to the seat, so as to accommodate the babies of different heights.

According to an embodiment of the present disclosure, the baby carrier is a baby carrycot, a stroller, a baby seat or an automobile safety seat.

The present disclosure provides a headrest plate for a baby carrier, and the headrest plate has an adjusting member that protrudes from the surface of the headrest plate, and the adjusting member is configured to have two or more through holes.

### BRIEF DESCRIPTION OF THE DRAWINGS

FIG. 1 shows a perspective view of a baby carrycot according to an embodiment of the present disclosure, with a headrest in a lower portion thereof;

FIG. 2 shows a perspective view of a baby carrycot according to an embodiment of the present disclosure, with a headrest in a middle portion thereof;

FIG. 3 shows a perspective view of a baby carrycot according to an embodiment of the present disclosure, with a headrest in an upper portion thereof;

FIG. 4 shows a sectional side view taken along a line I-I in FIG. 3;

FIG. 5 shows an enlarged view of a portion A of a headrest adjusting mechanism at a fixing member in FIG. 4;

FIG. 6 shows a front side view of a headrest plate of the headrest adjusting mechanism according to an embodiment of the present disclosure;

FIG. 7 shows a side view of the headrest plate according to an embodiment of the present disclosure;

FIG. 8 shows a perspective view of a baby carrycot according to an embodiment of the present disclosure, from which the headrest plate is removed;

FIG. 9 shows a detailed view at a fixing member in FIG. 8;

FIG. 10 shows a perspective view of a fixing member according to an embodiment of the present disclosure;

FIG. 11 shows a top view of a fixing member according to an embodiment of the present disclosure;

FIG. 12 shows a schematic sectional view of the fixing member taken along a line II-II in FIG. 11;

FIG. 13 shows a front view of an adjustment belt according to an embodiment of the present disclosure and a sectional view of the adjustment belt taken along a line III-III;

FIG. 14 shows a rear view of a headrest plate according to an embodiment of the present disclosure;

FIG. 15 shows a perspective view of a fixing member according to another embodiment of the present disclosure;

FIG. 16 shows a top view of the fixing member according to another embodiment of the present disclosure;

FIG. 17 shows a rear perspective view of a headrest plate according to another embodiment of the present disclosure;

FIG. 18 shows a side view of the headrest plate according to another embodiment of the present disclosure;

FIG. 19 shows a rear view of the headrest plate according to another embodiment of the present disclosure.

### REFERENCE SIGN LIST

1 baby carrier, baby carrycot
100 headrest adjusting mechanism
   110 headrest plate
      111, 111A, 111B adjusting member
      111a first positioning arm
      111b second positioning arm
      112 through hole
      113 side wing
      114A, 114B, 114C hollowed-out portion
      115 elastic arm
      116A first positioning member,
      116B second positioning member
      117 headrest mount
      118 resistance device
      119 anti-slip rib
   120 adjustment belt
      121 fixation hole
      122 raised portion
   130 fixing member
      131 bottom portion
      132 side portion
      133 connecting portion
      134 connection hole
      135 perforation
      136 positioning portion
      137A, 137B, 137C screw
      138 clamping wing
200 seat
   210 seat body
   220 backrest portion
   230 covering portion
   240 side pad
   250 hollowed-out portion
300 headrest
400 handle
I-I sectional line
II-II sectional line
III-III sectional line
A detailed portion

### DETAILED DESCRIPTION

Although the present disclosure is illustrated and described herein with reference to specific embodiments, the present disclosure should not be limited to presented details. Specifically, various modifications may be made to these details within a scope of equivalents of the claims without departing from the present disclosure.

Directions such as “front”, “back”, “upper” and “lower” mentioned herein are merely for convenience of understanding, and the present disclosure is not limited thereto, but can be adjusted according to actual circumstances. Although the present disclosure has been described with reference to typical embodiments, the terms used are illustrative and exemplary, but not restrictive.

Since the present disclosure may be embodied in various forms without departing from spirit and essence of the present disclosure, it should be understood that the above-mentioned embodiments are not limited to any of the foresaid details, but be construed as broadly as possible within a scope defined by the claims. Therefore, all changes that fall within the scope of the claims or their equivalents are intended to be covered by the claims.

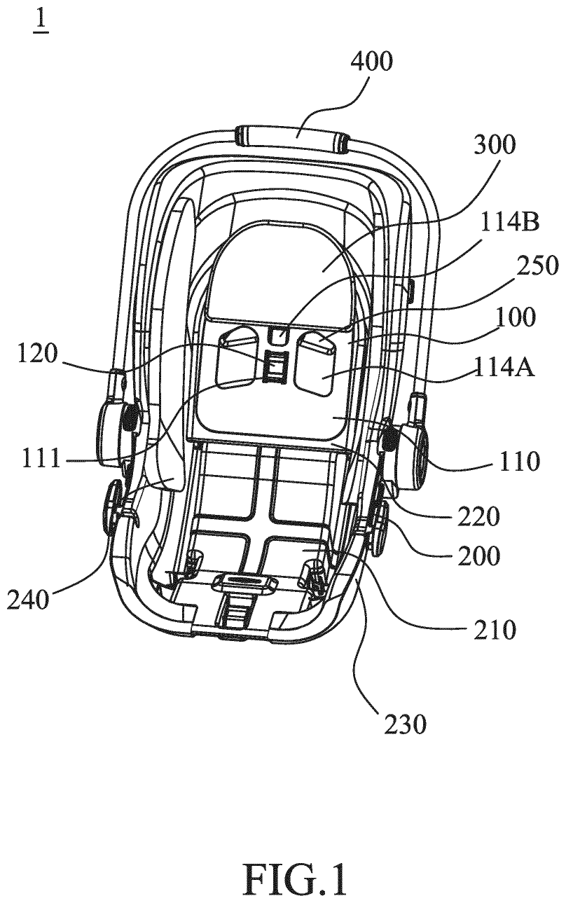

FIG. 1 shows a perspective view of a baby carrycot 1 according to an embodiment of the present disclosure. The baby carrycot 1 is a baby carrier 1, which may also be a stroller, a baby seat or an automobile safety seat. The baby carrycot 1 includes a seat 200, a handle 400 pivoted to the seat 200, and a headrest 300 slidably connected to the seat 200 and may be adjusted up and down along a longitudinal direction with respect to the seat 200 to accommodate babies of different heights. In order to adjust the headrest 300, the baby carrycot 1 further includes a headrest adjusting mechanism 100.

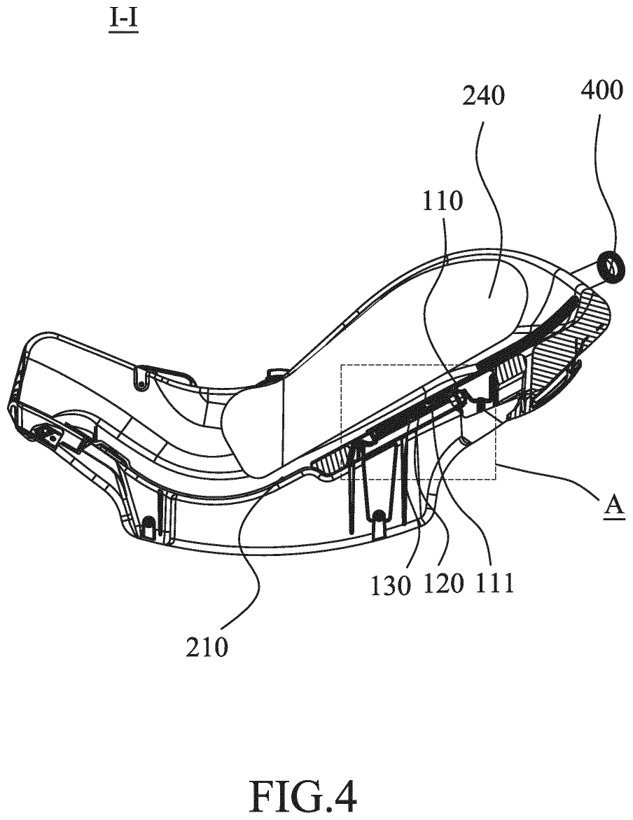

The baby carrycot 1 is especially used for carrying light-weight baby. For this purpose, the seat 200 is designed in a carrycot shape, allowing the baby to semi-recline in the baby carrycot 1 while being carried. The seat 200 includes a seat body 210 that has a bending structure (as shown in side view of FIG. 4) in order to enable the baby to be stably in a semi-reclined state. A covering portion 230 is integrally covered on a periphery of the seat body 210 and may be made of Expanded Polypropylene (hereinafter referred to as EPP) or other suitable cushioning materials. In this embodiment, a portion of a lower side of the seat body 210 that is not covered by the covering portion 230 may be used for, for example, the penetration of a safety belt and/or the installation of a seat cushion adapted to baby's lower body, and an upper side of the seat body 210 has a backrest portion 220 adapted to baby's upper body. The backrest portion 220 may be made of relatively soft materials, optionally EPP or other suitable materials, to increase comfort. According to this embodiment, side pads 240, which may be selected as a side wing inert foam, are provided on both sides of the seat 200, and the side pads 240 may be configured to cover entire sides of the seat 200 to provide lateral protection for the upper body including the baby's head. A handle 400 may be pivotally provided on both sides of the seat body 210 or the covering portion 230, so that the handle 400 may be basically perpendicular to the seat 200 in a carrying state, and may be pivotable to overlap with the seat 200 as shown in FIG. 1 in a non-carrying state.

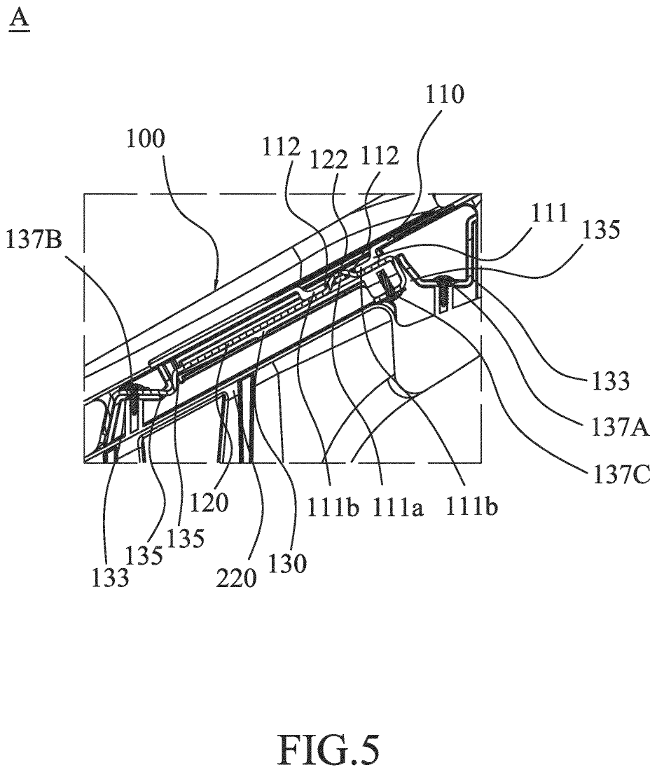

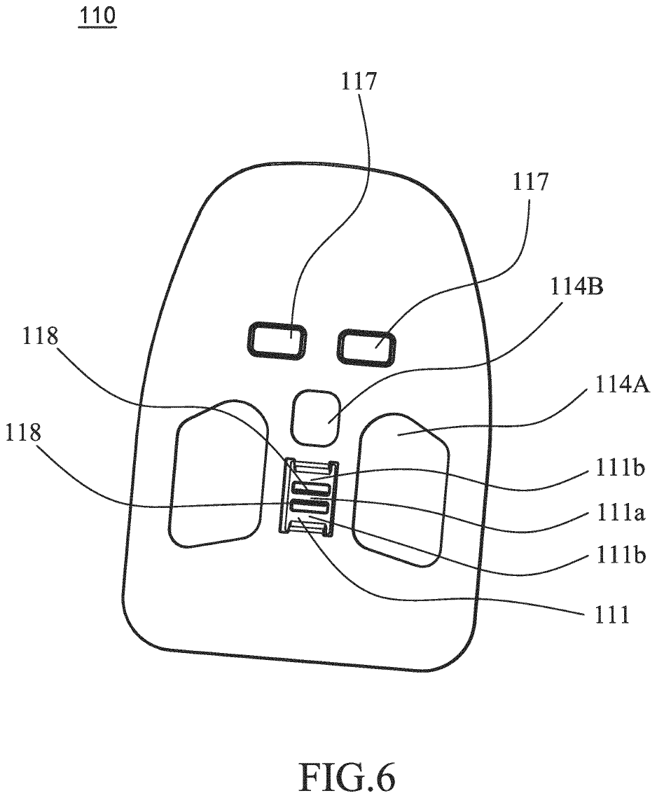

According to one or more embodiments of the present disclosure, the baby carrycot 1 is provided with a headrest adjusting mechanism 100 that includes a headrest plate 110 and an adjustment belt 120. The adjustment belt 120 is provided at the seat body 210, for example, fixed to the backrest portion 220 of the seat body 210, for connecting the headrest plate 110 and the seat body 210. The headrest plate 110 has an adjusting member 111, and the adjusting member 111 is operable to clamp the adjustment belt 120 for adjusting a position of the headrest plate 110 along a length direction of the adjustment belt 120. In some embodiments, the headrest plate 110 may optionally be a lightweight sheet-like structure, such as made of polypropylene (hereinafter referred to as PP). The adjustment belt 120 connects the headrest plate 110 to the backrest portion 220. In some embodiments, the adjustment belt 120 is made of a flat and belt-shaped flexible material such as a woven tape to make the headrest adjusting mechanism 100 more compact. In other embodiments, the adjustment belt 120 may also be an elastic rope having a circular cross section. Optionally, a surface of the woven tape is provided with a plurality of sewing lines (not shown) extending generally along a length direction perpendicular to the woven tape, such that the adjusting member 111 is more easily positioned on the sewing lines. The adjustment belt 120 in this embodiment is configured to be flat and pass through the adjusting member 111 on the headrest plate 110 (as shown in FIGS. 5 and 6). The headrest plate 110 may move up and down on the backrest portion 220, especially in a longitudinal direction of the backrest portion 220 through the adjustment belt 120. The headrest plate 110 is used to install the headrest 300 and adjust the position of the headrest 300, especially to adjust and position a relative longitudinal position of the headrest 300 and the backrest portion 220 along the longitudinal direction of the backrest portion 220. The headrest 300 may be integrally or separately configured with the headrest plate 110, for providing some cushioning to the baby's head. In an integral configuration, for example, a detachable soft sleeve may be provided outside the headrest 300, allowing it more comfortable and convenient to remove and wash. In a separated structure, the headrest 300 may also itself be made of soft materials, such as EPP, and may be detachably connected with the headrest plate 110 through a headrest mounting device. In FIG. 1, the headrest 300 is adjusted together with the headrest plate 110 to a lower position along the longitudinal direction of the backrest portion 220, accommodating babies with smaller heights.

Referring to FIGS. 5 and 6, according to an embodiment, an adjusting member 111 for clamping an adjustment belt 120 is provided on the headrest plate 110 (explained in detail later), and the adjusting member 111 is provided with a through hole 112 or rather an adjustment hole 112 for passing through the adjustment belt 120, and the adjusting member 111 cooperates with the adjustment belt 120 through the through hole 112 to adjustably fix the headrest plate 110 to a plurality of continuous positions in a longitudinal direction so as to meet the needs of the babies of different heights and also prevent the headrest 300 from moving up and down during being used. In FIG. 1, a plurality of hollowed-out portions 114A and 114B may be shown, and the hollowed-out portions 114A may be matched with the hollowed-out portions 250 in the backrest portion 220 or the seat body 210, to allow the passage of the shoulder straps of the baby carrycot and favorably reduce the weight of the components. In some embodiments, when the headrest plate 110 is adjusted to any position in the longitudinal direction, at least a portion of the hollowed-out portion 114A overlaps with the hollowed-out portion 250 in the seat body 210, so that the passage of the shoulder strap of the carrycot cannot be affected regardless of the heights of the headrest. The hollowed-out portion 114B is particularly designed for the installation and fixation of the headrest adjusting mechanism 100 (explained in detail later).

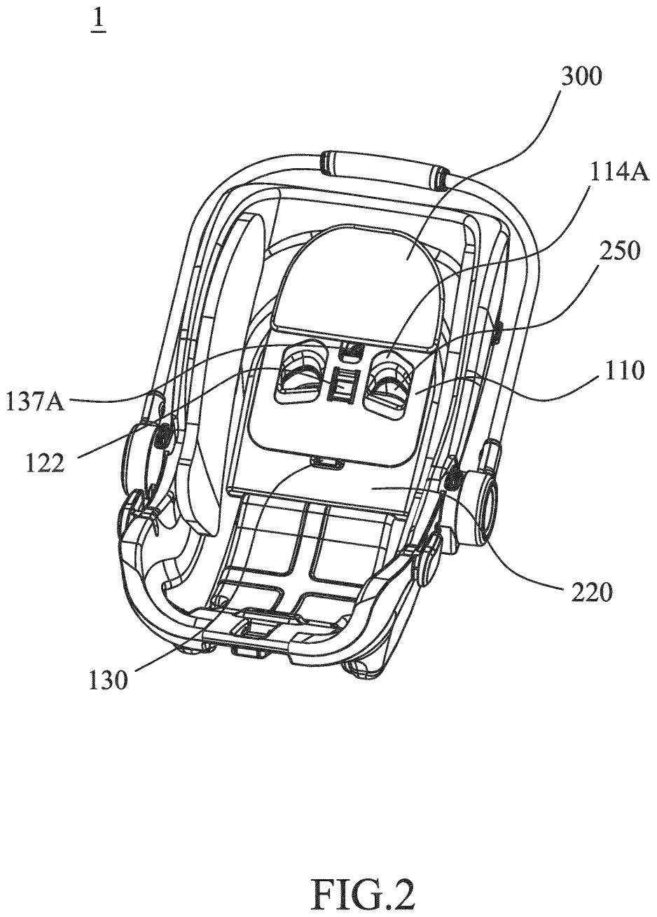

FIG. 2 shows a perspective view of the baby carrycot 1 according to an embodiment of the present disclosure. Compared to FIG. 1, the headrest plate 110, along with the headrest 300, has been adjusted to a middle position in the longitudinal direction to accommodate the babies of average height. The hollowed-out portion 114A of the headrest plate 110 moves upward in the longitudinal direction and completely exposes the hollowed-out portion 250. The baby carrycot 1 shown in FIG. 2 is not wrapped with a cloth cover, and the fixing member 130 is exposed at a lower side of the headrest plate 110, and the hollowed-out portion 114B exposes a screw 137A of the fixing member 130, which is used to connect with the backrest portion 220.

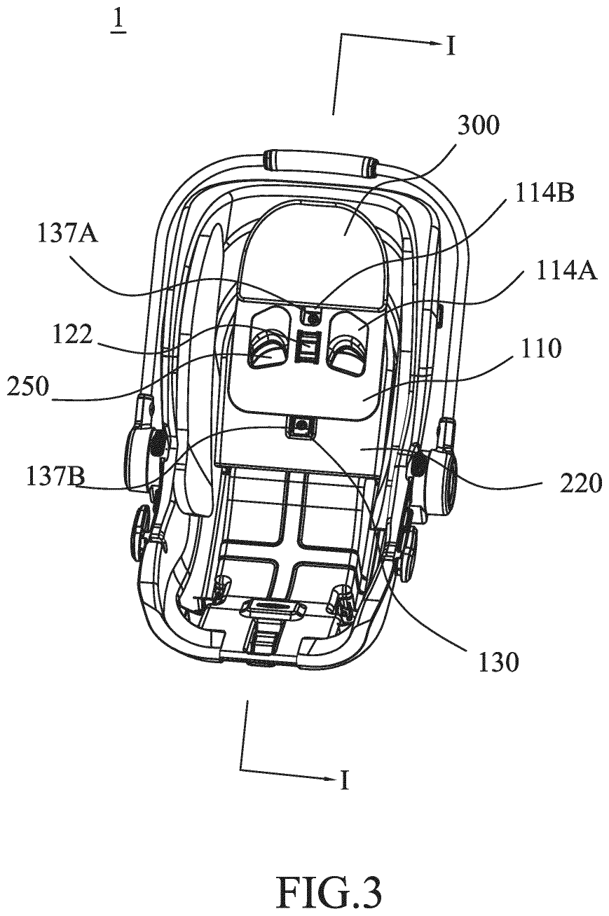

FIG. 3 shows a perspective view of the baby carrycot 1 according to an embodiment of the present disclosure. Compared to FIG. 2, the headrest is adjusted to an upper position in the longitudinal direction to accommodate babies of larger heights. The hollowed-out portion 250 is further located at a lower side of the hollowed-out portion 114A of the headrest plate 110. The fixing member 130 is exposed more at the lower side of the headrest plate 110. The baby carrycot 1 as shown in FIG. 3 is not wrapped with a cloth cover, so that a lower screw 137B for fixing the fixing member 130 on the backrest portion 220 may be seen while the upper screw 137A may also be seen.

FIG. 4 shows a sectional side view taken along a line I-I in FIG. 3. In FIG. 4, it can be seen that a bottom portion of the seat body 210 of the baby carrycot 1 is configured in an arc shape, so that the baby carrycot 1 may be used as a cradle when being laid on the ground. The baby is in a semi-reclined state in the baby cradle 1, in which the baby cradle 1 may be carried when the handle 400 is pivoted to be substantially perpendicular to the seat body 210. The headrest adjusting mechanism 100 of the present disclosure may be used to adjust a longitudinal position of the headrest 300 with respect to the backrest portion 220 of the seat 200. It not only has a simple structure and easy operation but also reduces the weight of the baby carrycot 1.

FIG. 5 shows an enlarged view of a portion A of the headrest adjusting mechanism 100 at the fixing member 130 in FIG. 4. The adjustment belt 120 is fixed to the fixing member 130, and the headrest plate 110 is adjustably fixed to the seat body 210. The fixing member 130 with the adjustment belt 120 are buried in the seat body 210 and are fixedly connected with the seat body 210 or the backrest portion 220 for covering the seat body 210 through screws 137A and 137B provided on the connecting portions 133 at both ends. The adjustment belt 120 has an upper end portion that passes through an upper perforation 135 of the fixing member 130 into a rear side of the fixing member 130, makes two turns around the fixing member 130, and then is bent to be fixed on a bottom side of the fixing member 130 by screws 137C; and a lower end portion that continuously passes through two lower perforation 135 and is fixed on the lower connecting portion 133 by screws 137B. The fixing embodiment of the adjustment belt 120 can be beneficial to adjust stress of the adjustment belt 120, for example, beneficial to stretch the adjustment belt 120. In addition, the connecting portion 133 of the fixing member 130 is configured to have an angle with respect to the backrest portion 220 or the seat body 210 and a bottom portion 131 of the fixing member 130, in order to fit an internal structure of the backrest portion 220 or rather the seat body 210. The connecting portion 133 of the fixing member 130 also has an angle with the bottom portion 131 of the fixing member 130 to form a receiving part for the screws 137A and 137B, thereby advantageously saving space and simplifying installation.

In this embodiment, a raised portion 122 of the adjustment belt 120 particularly can be seen. The headrest plate 110 is provided with an adjusting member 111 that clamps the adjustment belt 120, and the adjustment belt 120 provides the adjusting member 111 with a pressure to make the headrest plate 110 close to the seat body 210 and a friction force in the longitudinal direction, so that the headrest plate 110 can move freely along the length direction of the adjustment belt 120 when being pulled/pushed by the user, and remain in the current position when the pulling/pushing by the user stops. The headrest plate 110 may be integrated with the adjusting member 111 to make the structure simpler. In one or more embodiments, the adjusting member 111 protrudes from the surface of the headrest plate 110 to a direction facing the seat body 210.

The adjusting member 111 includes at least one first positioning arm 111a and at least two second positioning arms 111b provided at intervals. According to this embodiment, the adjustment belt 120 is flat and has a first face that abuts against the first positioning arm 111a of the adjusting member 111 and a second face that abuts against the second positioning arm 111b of the adjusting member 111. The first positioning arm 111a and the second positioning arm 111b are perpendicular to the length direction of the adjustment belt 120, and the first positioning arm 111a and the second positioning arm 111b may be in the same plane or in different planes. Through the first positioning arm 111a and the second positioning arm 111b, an adjustment hole 112 is formed on a bottom side of the adjusting member 111. Here, a [symbol] -shaped (i.e., a rectangle with one shorter horizontal line inserted at a center thereof) adjustment hole is formed by two parallel through holes 112, and the adjustment belt 120 in the flat shape passes through the two parallel through holes sequentially to form the raised portion 122. In the case that the first positioning arm 111a and the second positioning arm 111b are in different planes, the through holes 112 may also be formed on a side wall of the adjusting member 111, for example, one through hole 112 is provided on the bottom side and the other through hole 112 is provided on the side wall, and the present disclosure is not limited thereto. In addition, according to the present disclosure, the adjusting member 111 serves to clamp the adjustment belt 120, and the specific form of the adjusting member 111 is not limited to the [symbol] -shaped (i.e. 8-shaped) adjustment hole 112, for example, may be a [symbol] -shaped (i.e., a rectangle with two shorter horizontal lines inserted therein) or an unclosed E-shaped adjustment hole 112.

According to this embodiment, the adjustment belt 120 passes through the two through holes 112, so that the headrest plate 110 is connected to the backrest portion 220. Meanwhile, in order to adjust a position of the headrest 300 with respect to the backrest portion 220, the headrest plate 110 may be pulled along the longitudinal direction of the backrest portion 220, so that the adjusting member 111 with the [symbol] -shaped adjustment hole 112 moves along the adjustment belt 120. As the adjustment belt 120 pulls the headrest plate 110 against the backrest portion 220, due to a friction force between the adjustment belt 120 and the adjusting member 111, the movement of the headrest plate 110 with respect to the backrest portion 220 in a non-operating state can be prevented. In order to increase the friction force, tooth-like protrusions 118 as shown in FIG. 6 may be provided on a hole wall of the adjustment hole 112 at an aspect of the adjusting member 111. In addition, a resistance device may be formed at a surface of at least one of the first positioning arm 111a and the second positioning arm 111b abutting against the adjustment belt 120 to increase the friction between the adjusting member 111 and the adjustment belt 120. For example, a roughened portion may be provided on the first positioning arm 111a of the [symbol] -shaped adjustment hole 112, which forms the raised portion 122, facing the adjustment belt 120. In order to increase the friction force, the resistance device may also be a protrusion or a roughened portion, such as a sewing thread provided on the adjustment belt 120.

FIG. 6 shows a front side view of the headrest plate 110 of the headrest adjusting mechanism 100 according to an embodiment of the present disclosure. In this embodiment, the headrest plate 110 further includes a headrest mounting device (such as a headrest mount 117) for connecting the headrest 300, in addition to the hollowed-out portions 114A and 114B. In this embodiment, the adjustment belt 120 is removed from the adjusting member 111, so that the adjusting member 111 not covered by the adjustment belt 120 can be seen, and the adjusting member 111 includes at least one first positioning arm 111a and at least two second positioning arms 111b provided at intervals. According to this embodiment, through at least one first positioning arm 111a and at least two second positioning arms 111b, the adjusting member 111 is configured to have two through holes through which the adjustment belt 120 may pass. In this embodiment, the adjusting member 111 is configured as two parallel transverse slots, forming the [symbol] -shaped adjusting member 111. In this embodiment, in order to advantageously increase the friction between the adjustment belt 120 and the adjusting member 111, the resistance device 118 is provided on the hole wall of the adjusting member 111, and the resistance device 118 may be provided as a protrusion 118, and also as an stop-slip structure, an anti-slip rib, a tooth, a rough surface, etc. The protrusion 118 may be horizontally provided along a moving direction of the adjustment belt 120 as shown in FIG. 6, or may also be provided on other sides or all sides of the adjusting member 111 in the moving direction of the adjustment belt 120.

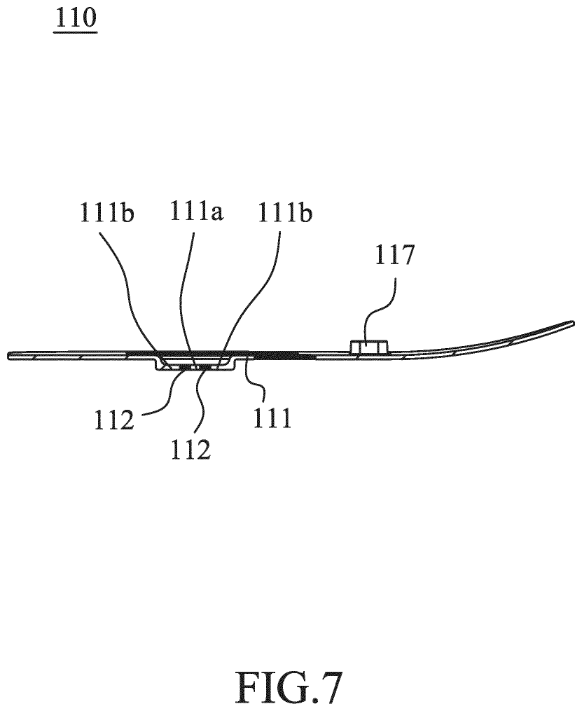

FIG. 7 shows a side view of the headrest plate 110 according to an embodiment. In this embodiment, the adjusting member 111 with two through holes 112 can be seen separately, and the headrest mount 117 protruding from the surface of the headrest plate 110 can also be seen. The adjusting member 111 includes at least one first positioning arm 111a and at least two second positioning arms 111b provided at intervals to form the through holes 112

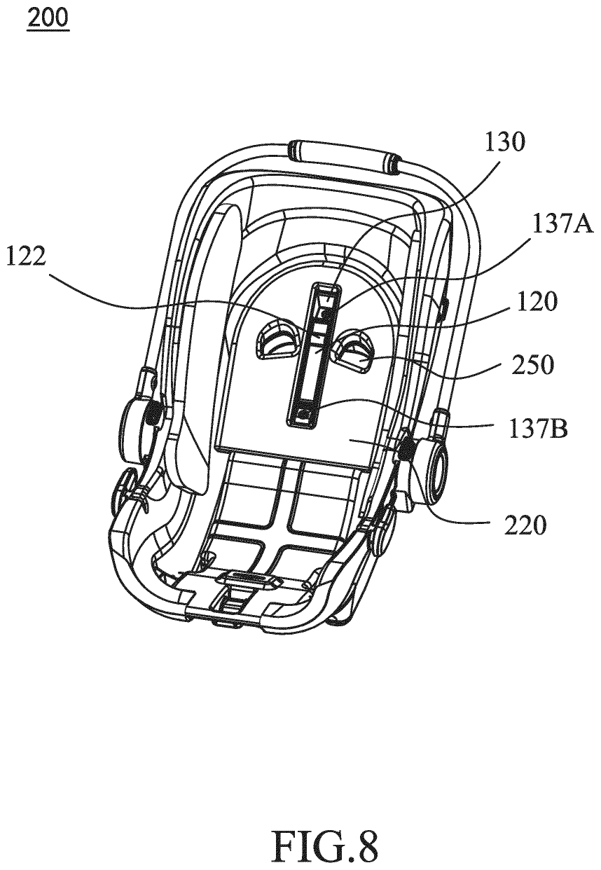

FIG. 8 shows a perspective view of the baby carrycot 1 according to an embodiment of the present disclosure. In FIG. 8, the headrest plate 110 is removed to expose details at the backrest portion 220. In this embodiment, two hollowed-out portions 250 may be provided in the backrest portion 220, and the fixing member 130 is provided between the two hollowed-out portions 250 along the longitudinal direction of the backrest portion 220. The fixing member 130 is provided on the backrest portion 220 along the longitudinal direction of the backrest portion 220, and both ends of the adjustment belt 120 are fixed to the fixing member 130. The fixing member 130 is fixedly connected to the backrest portion 220 or the seat body 210 covered by the backrest portion 220 by the screws 137A, 137B, and is provided to accommodate the adjustment belt 120. The adjustment belt 120 schematically indicates the raised portion 122 that is created by the adjusting member 111 (not shown).

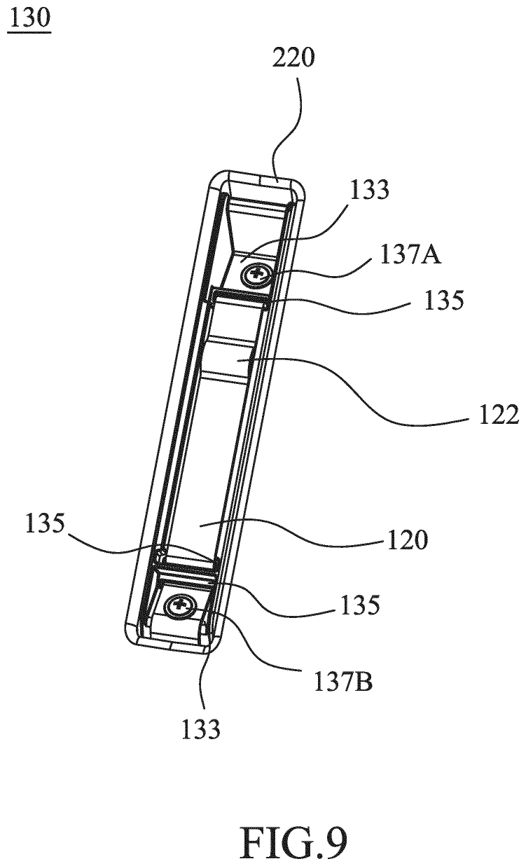

FIG. 9 shows a detailed view at the fixing member 130 in FIG. 8. The fixing member 130 is in a strip shape and adapted to width and length of the adjustment belt 120. In this embodiment, the fixing member 130 is configured to have a groove that extends substantially along the longitudinal direction of the backrest portion 220 or the seat body 210. The adjustment belt 120 is buried in the groove of the fixing member 130, and the fixing member 130 with the adjustment belt 120 is buried in the backrest portion 220, and are fixedly connected with the backrest portion 220 or the seat body 210 covered by the backrest portion 220 by the screws 137A and 137B provided on the connecting portions 133 at both ends thereof. The adjustment belt 120 has an upper end that passes through the upper perforation 135 of the fixing member 130 into the rear side of the fixing member 130, and a lower end that continuously passes through the two lower perforations 135 to be fixed to the lower connecting portion 133 by the screws 137B (see FIG. 5).

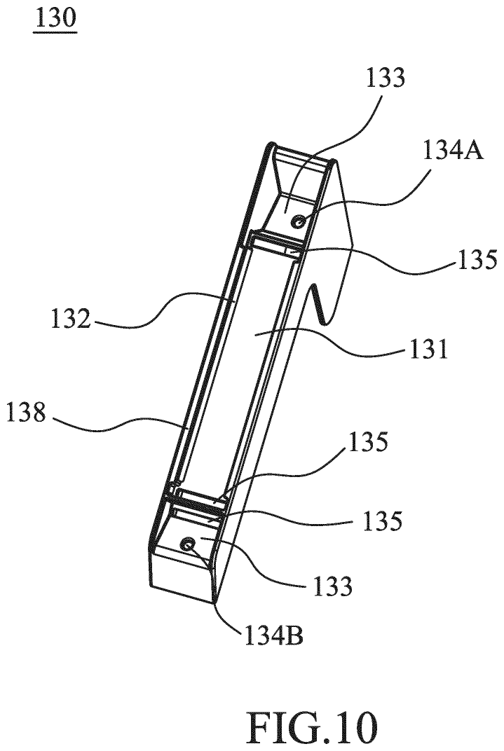

FIG. 10 shows a perspective view of the fixing member 130 according to an embodiment of the present disclosure. In FIG. 10, as the adjustment belt 120 in FIG. 9 is removed, the groove provided in the fixing member 130 may be seen. The groove has a bottom portion 131 against which the adjustment belt 120 abuts and side portions 132 which are respectively located on both lateral sides of the bottom portion 131. In this embodiment, clamping wings 138 are provided in a middle of the two side portions 132 along the longitudinal direction, and the clamping wings 138 and the bottom portion 131 form a guide groove for guiding sliding of the adjusting member 111. As guiding the adjusting member 111, the guide groove can also be used advantageously to prevent the headrest plate 110 from disengaging from the fixing member 130 and further from disengaging from the backrest portion 220. In this embodiment, one transverse perforation 135 at an upper end and two transverse perforations 135 at a lower end, for example, forming a H shape, are shown in FIG. 9. The screws 137A and 137B for fastening the fixing member 130 to the backrest portion 220 may be fastened through the connection hole 134 provided on the connecting portion 133 of the fixing member 130.

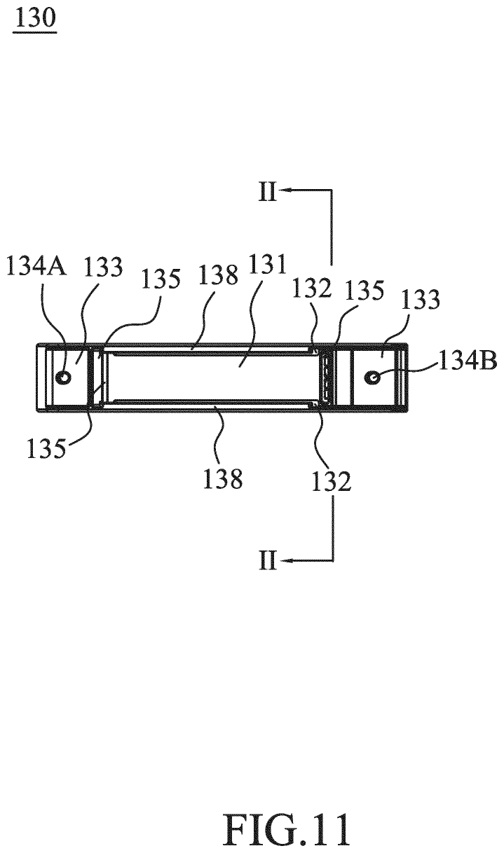

FIG. 11 shows a top view of the fixing member 130 according to an embodiment of the present disclosure. In this figure, the clamping wings 138 arranged on the two side portions 132 of the fixing member 130 are shown. A symmetrical arrangement of the two clamping wings 138 can better guide stable movement of the adjusting member 111 and the adjustment belt 120.

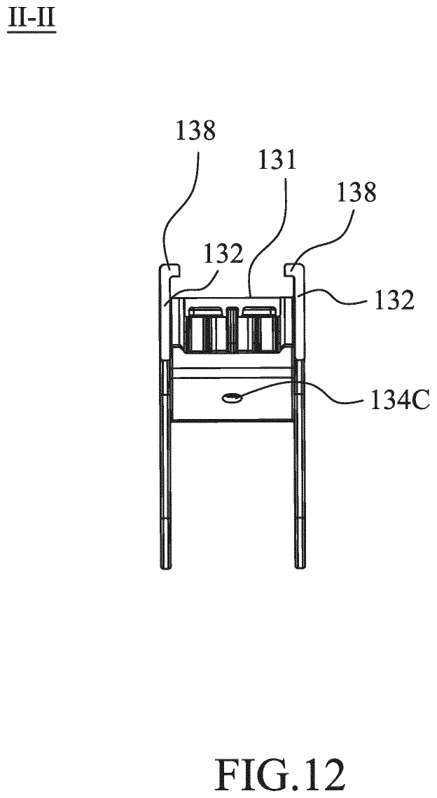

FIG. 12 shows a schematic sectional view of the fixing member 130 taken along a line II-II in FIG. 11. FIG. 12 schematically shows positions of the clamping wings 138, and a guide groove is formed between the clamping wing 138 and the bottom portion 131 for guiding the sliding of the adjusting member 111.

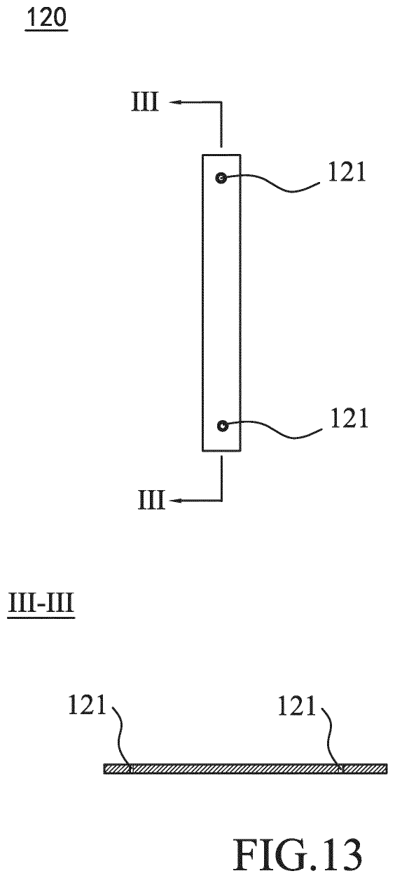

FIG. 13 shows a front view of the adjustment belt 120 according to an embodiment of the present disclosure and a sectional view of the adjustment belt taken along a line III-III. The adjustment belt 120 is configured as a flat strip, for example, which may be made of flexible materials, such as fabrics. The adjustment belt 120 has a rough surface to increase the friction coefficient or may form a protrusion on the surface to increase the friction force between the adjustment belt 120 and the adjusting member 111. Additionally, a plurality of resistance devices (not shown) facing the adjusting member 111, for example, may be provided on the adjustment belt 120 along the longitudinal direction to increase the friction force of the adjustment belt 120 with respect to the adjusting member 111. According to the present disclosure, the resistance devices may be protrusions, which may be sewing threads provided on one side of the adjustment belt 120 or other structures formed on the adjustment belt 120 itself. The resistance device may also be provided on upper and lower sides or on either side of the adjustment belt 120 to increase the friction force with the sides of the backrest portion 220 individually or additionally. FIG. 13 also shows two fixation holes 121 for fixing the adjustment belt 120 on both ends of the fixing member 130. According to the present disclosure, the fixation holes 121 may not be provided, but the screws 137A and 137B (see FIG. 5) may be used to directly penetrate the flexible adjustment belt 120 for fixation.

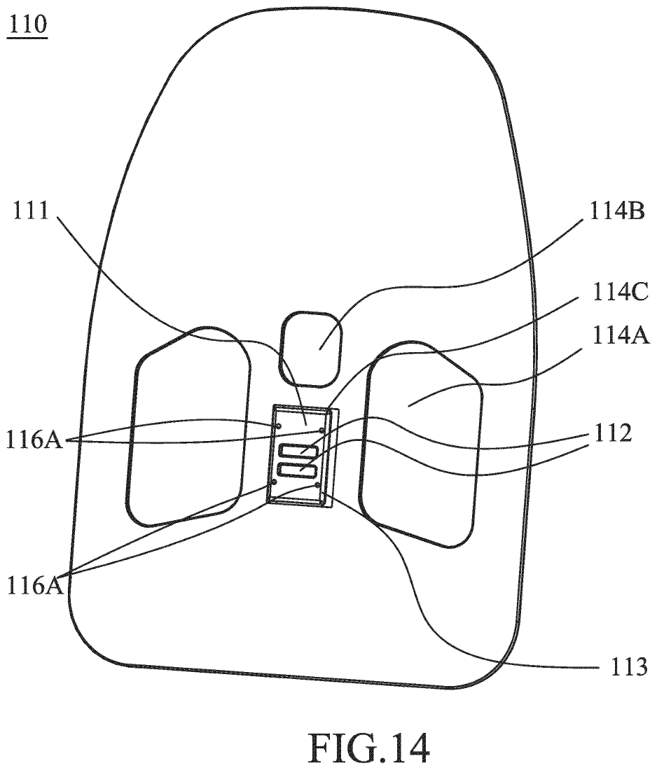

FIG. 14 shows a rear view of the headrest plate 110 according to an embodiment. In this embodiment, the headrest plate 110 is adapted to the fixing member 130 according to FIGS. 9 to 12 of the present disclosure. The headrest plate 110 has hollowed-out portions 114A through which the shoulder straps may pass in the longitudinal direction, and a hollowed-out portion 114B for a screw 137A used to install the fixing member 130. The headrest plate 110 has a hollowed-out portion 114C (protruding part) in a horizontal middle thereof, and the adjusting member 111 is formed in the hollowed-out portion 114C. Specifically, the adjusting member 111 is connected to a main body of the headrest plate 110 at both ends of the headrest plate 110 in the longitudinal direction, and on a bottom side vertically raised with respect to the headrest plate 110 in FIG. 14 of the adjusting member 111, the two side wings 113 (only one side wing 113 is shown for sake of viewing angle) are symmetrically provided on both sides of the bottom side thereof along a lateral direction. The side wings 113 protrude from the adjustment belt 120 in the lateral direction and is able to be inserted into the guide groove in FIG. 12, such that the adjusting member 111 is slidable in the guide groove and prevents the headrest plate 110 from disengaging from the backrest portion 220.

Two through holes 112 are formed in a middle of the bottom side of the adjusting member 111 along the longitudinal direction, to form a [symbol] -shaped adjusting member 111 through which the adjustment belt 120 passes. The adjustment belt 120, along with the side wing 112, cooperates with the fixing member 130 to realize the relative displacement and positioning of the headrest plate 110 with respect to the backrest portion 220 in the longitudinal direction, without requiring other complicated mechanisms. This can save cost and reduce weight.

Additionally or alternatively, according to the present disclosure, the adjusting member 111 may have positioning members 116A. The positioning members are symmetrically provided outside the through hole 112 in the lateral direction of the headrest plate 110, avoiding the position of the adjustment belt 120. Herein, four positioning members 116A are provided and are shaped as convex portions or rather positioning protrusions in circular or other shapes protruding from the bottom side. The positioning members 116A and the positioning portions such as concave portions or rather positioning recesses on the groove of the fixing member 130 are matched (i.e., inserted) with each other in shape, so as to position the headrest plate 110.

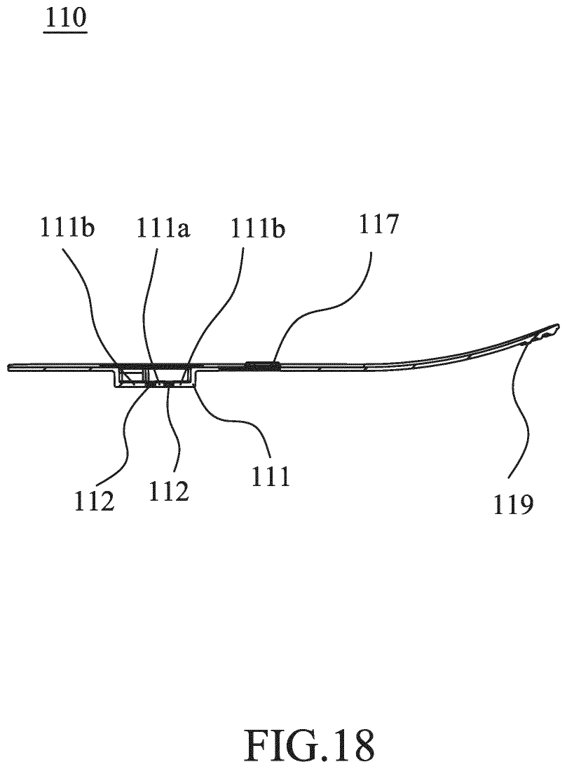

The positioning members 116A may be provided on an outer surface of the adjusting member 111 facing a bottom portion 131 of the groove of the fixing member 130 or on the outer surface of the adjusting member 111 facing the side portions 132 of the groove. In this embodiment, the positioning member 116A is vertically provided on an outer surface of the bottom side of the adjusting member 111 facing the bottom portion 131 of the groove of the fixing member 130. When the convex portions or the positioning protrusions are provided in a vertical direction, an upper end of the headrest 300 (for example, an anti-slip rib 119 in FIG. 18) is pulled by user to adjust a height of the headrest 300. Due to the curvature of the headrest 110, i.e., the upper end of the headrest plate 110 is not in the same horizontal plane as the adjusting member 111, when the position of the headrest 300 is to be adjusted, on the one hand, a pulling force for making the headrest plate 110 far away from the seat body is applied to the headrest plate 110 in the vertical direction, such that the convex portions or the positioning protrusions on the surface of the adjusting member 111 of the headrest plate 110 at least partially disengage from the positioning recesses on the fixing member 130, thereby reducing the resistance when adjusting the height of the headrest 300; on the other hand, a pulling force is provided for the headrest 300 in the longitudinal direction to adjust the height of the headrest 300 along the length direction of the adjustment belt 120. Compared to the case where the convex portions or rather the positioning protrusions are provided on the outer surface facing the side portions 132 of the groove, the additional beneficial effect can be achieved when the convex portions or rather the positioning protrusions are provided on the outer surface facing the bottom portions 131 of the groove.

In addition to the positioning members 116A being configured as the convex portions or rather the positioning protrusions, and the positioning portions on the groove of the fixing member 130 being configured as concave portions or rather positioning recesses, it is also possible to provide a reverse configuration, i.e., the convex portions or rather the positioning protrusions are provided on the groove of the fixing member 130, and the concave portions or rather the positioning recesses are provided on the adjusting member 111.

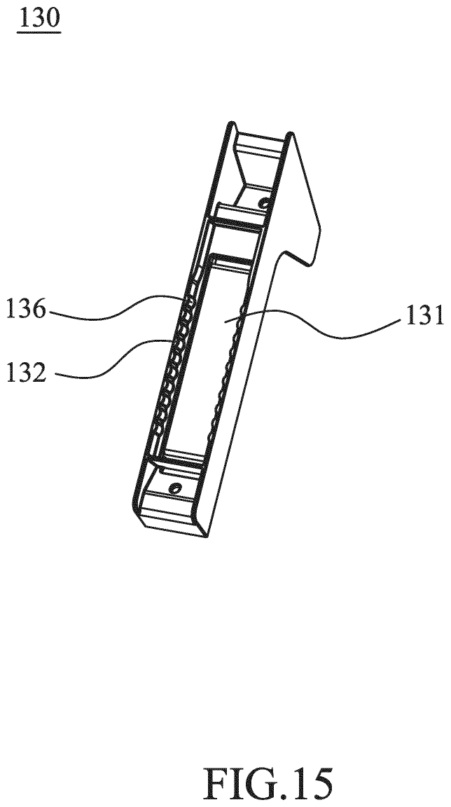

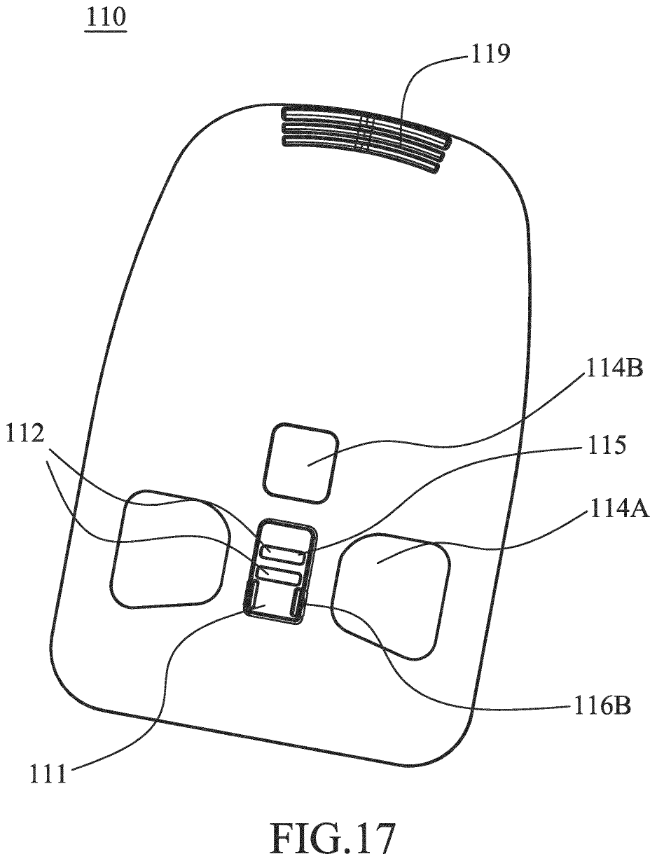

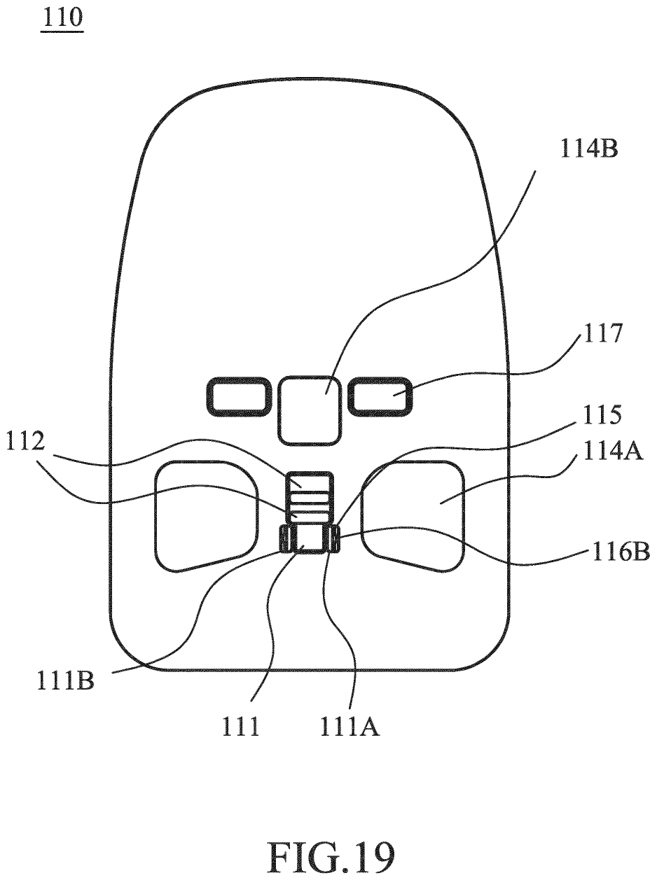

FIG. 15 shows a perspective view of the fixing member 130 according to another embodiment of the present disclosure. Different from a first embodiment in FIG. 10, there is no clamping wings 138, instead, positioning portions 136 are provided in the side portions 132 of the groove. The positioning portions 136 are configured as wave-shaped positioning portions provided along the longitudinal direction, and the positioning member 116B (see FIGS. 17 and 19) provided on the adjusting member 111 of the headrest plate 110 moves along the wave-shaped positioning portion and is positioned in a trough. In other words, in this embodiment, a plurality of positioning portions 136 in form of positioning recesses are provided, and a plurality of positioning recesses are provided inside the side portions 132 of the groove of the fixing member 130, and the convex portion is provided between two adjacent positioning recesses. When moving the adjusting member 111, the positioning member 116B in the form of positioning protrusions may be positioned in the positioning recesses over the convex portions, so as to stop the headrest 300 at an expected height.

The positioning protrusions on the headrest plate 110 are matched with the positioning recesses on the positioning member 130, to further position the headrest 300 and favorably achieve a segmentation sense during the adjustment process. As adjusting the headrest 300, when the positioning protrusions correspond to the convex portions on the fixing member 130, the positioning member 116B on an elastic arm 115 is deformed, and the headrest 300 continues to be adjusted, and the positioning protrusions cooperate with the positioning recesses to achieve the positioning of the headrest 300.

According to this embodiment, the positioning portion 136 may better position the headrest plate 110 or the headrest 300 and prevent it from sliding, while the adjustment belt 120 may connect the headrest plate 110 to the fixing member 130 or rather the backrest portion 220 by using more diverse materials or forms.

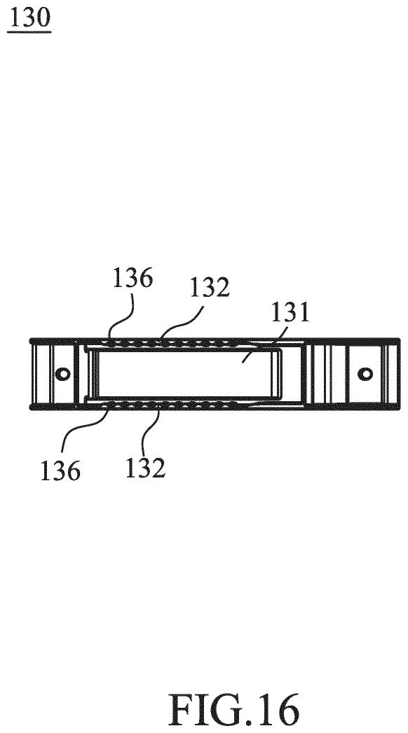

FIG. 16 shows a top view of a fixing member 130 according to another embodiment of the present disclosure. Each of troughs and peaks of the wave-like positioning portion 136 extends substantially perpendicular to the bottom portion 131.

FIG. 17 shows a rear view of the headrest plate 110 according to an embodiment. The headrest plate 110 in this embodiment is adapted to the fixing member 130 as shown in FIGS. 15 and 16. The headrest plate 110 has hollowed-out portions 114A through which the shoulder straps pass, and a hollowed-out portion 114B for the screw 137A for installing the fixing member 130. In addition, the upper side of the headrest plate 110 is also provided with one or more, here, three anti-slip ribs 119. The anti-slip ribs 119 are used for anti-slip between the headrest plate 110 and the backrest portion 220, thereby advantageously preventing the movement of the headrest plate 110 with respect to the backrest portion 220. Another purpose of the anti-slip ribs 119 is to allow users to grip this portion to adjust the height of the headrest 300, which increases the friction force between a hand and the headrest plate 110.

An adjusting member 111 is configured in the lateral middle of the headrest plate 110, and two through holes 112 are formed in the bottom side of the adjusting member 111 to form a [symbol] -shaped adjusting member 111 through which the adjustment belt 120 may pass.

Different from the embodiment of FIG. 14, in order to cooperate with the positioning portions 136 in the fixing member 130 of FIGS. 15 and 16, according to this embodiment, two positioning members 116B are provided at a lower portion of the bottom side of the adjusting member 111 and are shaped as protrusions or rather positioning protrusions. The positioning members 116B are integrally configured on an elastic arm 115 hollowed out of a lateral side of the adjusting member 111, for example. The hollowed-out portion provides a deformation space for the positioning members 116B, that is, the positioning member 116B, while moving in the wave-like positioning portion 136 of the groove of the fixing member 130 as shown in FIGS. 14 and 15, is pressed against the adjusting member 111 at the peak and is ejected to the side portions 132 of the groove at the trough under the action of the elastic arm 115, and stops in the corresponding trough, so as to achieve the stable positioning of the headrest plate 110 with respect to the backrest portion 220.

The adjustment belt 120 may, together with the positioning members 116B, advantageously achieve relative displacement and positioning of the headrest plate 110 with respect to the backrest portion 220 through the cooperation with the fixing member 130, without the need for other complicated mechanisms, thus saving cost and reducing weight.

FIG. 18 shows a side view of the headrest plate 110 according to another embodiment. Different from FIG. 16, the adjusting member 111 has a large depression depth, and a headrest mount 117 is configured to be lower. According to this embodiment, the anti-slip rib 119 provided on the headrest plate 110 may also be seen.

FIG. 19 shows a rear view of the headrest plate 110 according to another embodiment. The headrest plate 110 according to this embodiment is adapted to the fixing member 130 of FIGS. 15 and 16. The headrest plate 110 has hollowed-out portions 114A through which safety belts may pass, and a hollowed-out portion 114B for a screw 137A used to mount the fixing member 130. In addition, the headrest plate 110 also has a headrest mount 117 for mounting the headrest 300.

Different from the embodiment of FIG. 17, in order to cooperate with the positioning portion 136 in the fixing member 130 of FIGS. 15 and 16, two additional adjusting members 111A are symmetrically provided on both sides of the adjusting member 111 in FIG. 19, and the adjusting members 111A are also lifted upward from the headrest plate 110 and optionally lifted by the same height as the adjusting member 111. An elastic arm 115 is hollowed out of the adjusting member 111A, and the positioning member 116B is provided on the elastic arm 115. According to this embodiment, the adjusting member 111 may be designed to be narrower in the lateral direction, for example, to accommodate a narrower adjustment belt 120, it is required that only a distance between the positioning members 116B in the two adjusting members 111A is matched with a width of the groove of the fixing member 130. According to this embodiment, it is advantageous to variously design the adjusting member 111 and related components, such as the adjustment belt 120.

The present disclosure provides a headrest structure of a baby carrycot 1, which includes an adjustment belt 120 fixed to a seat 200, and an adjusting member 111 provided on the headrest plate 110. The adjustment belt 120 is threaded through the adjusting member 111 to realize the connection between the headrest 300 and the seat 200, and the friction between the adjustment belt 120 and the adjusting member 111 provides a force for positioning the headrest 300 to different heights of the seat 200.

By securely connecting the adjustment belt 112 to the region of the backrest portion 220 of the seat 200 of the baby carrycot 1, and directly creating the adjusting member 111 on the headrest plate 110, the adjustment belt 120 is threaded through the adjusting member 111 to achieve the connection and adjustment positioning of the headrest 300 and the seat 200. The structure is simple, the adjustment belt 120 is lightweight, and the headrest plastic is also thin and lightweight, so that an overall weight of the baby carrycot 1 is lighter, which provides convenience for caregivers when carrying the baby carrycot 1 during travel.

Since the present disclosure can be embodied in various forms without departing from the spirit and essence of the disclosure, it should be understood that the above-mentioned embodiments are not limited to any of the foregoing details, but should be construed as broadly as possible within the scope defined by the claims, and therefore all changes that fall within the scope of the claims or their equivalents are intended to be covered by the claims.

1. A headrest adjusting mechanism for adjusting a position of a headrest with respect to a seat body of a baby carrier, wherein the headrest adjusting mechanism comprises:
a headrest plate; and
an adjustment belt provided at the seat body for connecting the headrest plate and the seat body,
wherein the headrest plate has an adjusting member configured to clamp the adjustment belt, for adjusting a position of the headrest plate along a length direction of the adjustment belt.

2. (canceled)

3. The headrest adjusting mechanism according to claim 1, wherein the adjusting member protrudes from a surface of the headrest plate towards a direction facing the seat body.

4. The headrest adjusting mechanism according to claim 1, wherein the adjusting member comprises at least one first positioning arm and at least two second positioning arms provided at intervals, and
the adjustment belt is flat and has a first face and a second face, wherein the first face abuts against the first positioning arm of the adjusting member and the second face abuts against the second positioning arm of the adjusting member.

5. (canceled)

6. The headrest adjusting mechanism according to claim 4, wherein the first positioning arm and the second positioning arm are in a same plane or in different planes, and the headrest plate and the adjusting member are integrated.

7. The headrest adjusting mechanism according to claim 4, wherein a resistance device is formed at a surface of at least one of the first positioning arm and the second positioning arms abutting against the adjustment belt to increase friction between the adjusting member and the adjustment belt.

8. The headrest adjusting mechanism according to claim 7, wherein the resistance device is a tooth-shaped protrusion and is provided on a surface of the adjusting member facing the adjustment belt.

9. The headrest adjusting mechanism according to claim 1, wherein the adjusting member is configured to have two or more through holes, and the adjustment belt is configured to pass through the through holes.

10. The headrest adjusting mechanism according to claim 1, wherein the adjustment belt has a plurality of sewing lines extending perpendicular to the length direction of the adjustment belt.

11. The headrest adjusting mechanism according to claim 1, wherein the headrest adjusting mechanism comprises a fixing member provided on the seat body along a longitudinal direction of the seat body, and fixing the adjustment belt to the seat body, and
wherein the fixing member is configured to have a groove extending substantially along the longitudinal direction of the seat body, and the groove has a bottom portion and side portions respectively at both lateral sides of the bottom portion.

12. (canceled)

13. The headrest adjusting mechanism according to claim 11, wherein the adjusting member has side wings respectively at the both lateral sides, and the side wings are inserted and matched with the side portions of the fixing member, such that the headrest plate is able to slide and position with respect to the seat body.

14. The headrest adjusting mechanism according to claim 11, wherein the adjusting member has a positioning member, and the positioning member cooperates with positioning portion on the groove to position the headrest plate.

15. The headrest adjusting mechanism according to claim 14, wherein the positioning member is provided on an outer surface of a bottom side of the adjusting member facing the bottom portion of the groove.

16. The headrest adjusting mechanism according to claim 13, wherein the positioning member is provided on an outer surface of the adjusting member facing the side portions of the groove; and
wherein the positioning portion is configured as wave-shaped positioning portion, and the positioning member moves along the wave-shaped positioning portion and realizes being positioned in a trough.

17. (canceled)

18. The headrest adjusting mechanism according to claim 16, wherein the adjusting member is provided with an elastic arm, and the elastic arm is deformable in a direction perpendicular to the longitudinal direction; and
the positioning member is configured on the elastic arm.

19. (canceled)

20. The headrest adjusting mechanism according to claim 14, wherein one of the positioning member and the positioning portion is presented as a plurality of convex portions, and the other of the positioning member and the positioning portion is presented as a plurality of concave portions matched with the convex portions.

21. The headrest adjusting mechanism according to claim 11, wherein along the longitudinal direction of the seat body, the adjustment belt has an upper end fixed to a bottom side of the fixing member through a perforation in upper part of the fixing member, and a lower end fixed to outside the fixing member through a perforation in lower part of the fixing member.

22. The headrest adjusting mechanism according to claim 1, wherein anti-slip rib is provided on a surface of the headrest plate facing the seat body;
wherein the adjustment belt is made of a flexible material; and
wherein the adjustment belt (120) is a woven tape.

23. (canceled)

24. (canceled)

25. A baby carrier, wherein the baby carrier comprises:
a seat body;
a headrest; and
the headrest adjusting mechanism according to claim 1 provided between the seat body and the headrest.

26. The baby carrier according to claim 25, wherein the headrest plate has a sheet-like structure, the headrest plate has a plurality of headrest plate hollowed-out portions, the seat body has seat body hollowed-out portions, and at least a portion of headrest plate hollowed-out portions overlaps with the seat body hollowed-out portions when adjusting the position of the headrest plate in a length direction of the adjustment belt.

27. The baby carrier according to claim 26, wherein the baby carrier is a baby carrycot, a stroller, a baby seat or an automobile safety seat.

28. (canceled)
